(19) United States
(12) Patent Application Publication
(10) Pub. No.: US 2022/0316937 A1
(43) Pub. Date: Oct. 6, 2022

(54) Liquid Transfer Device with Integrated Non-Contact Liquid Fill Height and Distance Sensor, and Methods

(71) Applicant: Hans-Christian Luedemann, Bolton, MA (US)

(72) Inventor: Hans-Christian Luedemann, Bolton, MA (US)

(21) Appl. No.: 17/843,902

(22) Filed: Jun. 17, 2022

Related U.S. Application Data
(63) Continuation of application No. PCT/US18/39424, filed on Jun. 26, 2018.
Application No. PCT/US18/39424 is a division of application No. 16/727,419, filed on Dec. 26, 2019.
(60) Provisional application No. 62/524,731, filed on Jun. 26, 2017.

(51) Int. Cl. G01F 23/292; G01F 23/296

(52) U.S. Cl. CPC G01F 23/2928; G01F 23/296; B01L 3/0293

(57) ABSTRACT

An apparatus, system, and method combining a liquid transfer device with a non-contact liquid fill height sensor to improve the reliability, accuracy, and precision of liquid transfers and to determine liquid fill height and liquid volume in a container before or after liquid transfers.

### CROSS-REFERENCE TO RELATED APPLICATIONS

This application is a divisional of and claims priority of application Ser. No. 16/727,419 filed on Dec. 6, 2019, which itself is a continuation of and claims priority to PCT Application No. PCT/US18/39424, filed on Jun. 26, 2018, which itself claims priority to Provisional Patent Application 62/524,731 filed on Jun. 26, 2017.

### FIELD

This disclosure relates to a liquid transfer device with an integrated non-contact distance sensor. Measurements taken with the integrated non-contact distance sensor are used to position a pipet tip of the liquid transfer device optimally for improving the reproducibility, reliability, accuracy, and precision of liquid transfers and to determine liquid fill height and liquid volume in a container before or after liquid transfers.

### BACKGROUND

Research and development in the life sciences, in the pharmaceutical industry, as well as in clinical diagnostics, and in chemistry rely heavily on automated liquid transfer devices.

An integrated liquid fill height sensor allows the liquid transfer device to perform at higher levels of accuracy of transferred volumes, precision of transferred volumes, and reproducibility. In most cases, transferring liquids relies on submerging a pipet tip, nozzle or needle underneath the surface of the liquid and aspirate the desired amount of liquid, for example using a syringe pump connected to the pipet tip. To reliably aspirate the desired volume, it is important that the opening at the distal end of the aspiration device is submerged far enough in the liquid so that only liquid is aspirated and the aspiration of air is avoided. If larger volumes are aspirated from relatively small containers, the fill height of the container may drop beneath the height of the pipet tip, and it is important to submerge the tip far enough to ensure that the opening of the pipet tip remains submerged throughout the aspiration step. On the other hand, the tip cannot be submerged too deeply, to avoid that the container overflows due to the liquid volume displaced by the pipet tip.

In many practically relevant cases, the liquid fill level of the container from which a liquid handling device is aspirating is not well defined. One such example is a patient sample of a bodily fluid such as blood, urine, saliva, or others, which is typically delivered to a liquid handling device in a diagnostic laboratory in test tubes or containers that were filled with low precision during a patient visit at a physician's office. Another example is automated equipment to extract nucleic acids from tissue samples. These instruments deliver small but imprecise volumes of several microliters of nucleic acid solution (eluate) in microplates or similar containers. Yet another example is a trough filled with an aqueous solution or an organic solvent, resting on the deck of an automated liquid handling robot. Over time, some of this solvent evaporates, and reliable liquid transfers demand that the liquid fill height be assessed independently before aspiration to ensure that sufficient volume is present in the container before the desired volume of liquid is aspirated.

The second element of a liquid transfer is the reliable dispensing of liquid volumes into containers that may be empty or partially filled. The reproducibility of the transfer depends on whether the opening of the dispensing pipet tip was submerged in the destination container, and on how far it was submerged. Liquid may adhere to the outside of the dispensing pipet tip, or a small amount of liquid may be left inside the pipet tip after the end of the dispense step, and be carried away with it after the dispense process is complete. The volume of liquid that remains adhering to the pipet tip depends on the properties of the liquid, the pipet tip, and how much of the pipet tip's surface area was wetted by the liquid during the dispensing step. Wetting the inside surface of the pipet tip during aspiration is unavoidable, but for similar aspiration volumes, the wetted surface area varies little, so wetting of the inside has limited effect on the reproducibility of liquid transfers. However, the wetting of the outside surface can be controlled by monitoring and controlling how deep the pipet tip is submerged.

In the case of aspirating liquid from the container, the pipet tip can be submerged to a desired depth. Once the pipet tip has reached this position, the liquid transfer device can begin aspirating liquid from the container. Techniques to vary the pipet tip height relative to the container during aspiration are well known in the industry. Similarly, by submerging, the tip will displace liquid and thus affect the liquid fill height in the container. Techniques to compensate for this based on the geometry of the container and the tip and the implied liquid displacement and liquid level rise are also well known in the industry.

Several manufacturers of liquid transfer devices use contact based liquid level sensors. One commonly employed scheme uses conductive pipet tips and measures the capacitance between the pipet tip and the deck of the liquid transfer device on which the sample container rests during operation. In the case of conductive samples such as aqueous salt or buffer solutions, the capacitance decreases when the tip of the pipet touches the sample, permitting fill height detection. This method does not work for non-conductive or low-conductivity liquids.

In another commonly employed scheme, a stream of air is continuously aspirated while the pipet tip is submerged into the liquid. The pressure in the pipet tip is measured and a pressure decrease indicates that the opening of the pipet tip has pierced the liquid surface. When that occurs, the free flow of air into the opening of the pipet tip is inhibited by the aspiration of liquid, which is more viscous than air. As the plunger of the attached syringe pump continues to withdraw, a pressure decrease is detected.

In the case of dispensing liquid into a container, it may be desirable to move the pipet tip to a defined position relative to the empty container or the liquid surface. In some cases, more reliable liquid transfers are obtained by submerging the pipet tip in the liquid, in other cases, better results are obtained by moving the pipet tip to a defined elevation above the liquid or container surface. Once a droplet exits from the pipet tip, it may adhere to the inside of the container or to the liquid already in the container. When the tip is retracted following the dispense, this adhesion will minimize liquid carried off with the pipet tip and thus ensure reproducible liquid transfers. In other cases, for example when the same pipet tip is used to add solvent to several containers, it is desirable that the tip does not touch the contents of the container to avoid cross-contamination.

In aspiration steps, it is often important to collect as much of the sample as possible, which necessitates moving the opening of the pipet tip as close as possible to the bottom of the container without pressing against the opening to avoid sealing the opening, which would preclude the desired, slow aspiration. Instead, a vacuum builds up inside the tip and then, when the tip is retracted and the seal with the bottom of the container is broken, liquid rushes into the pipet tip and may wet elements of the mechanism that should not ordinarily be wetted.

### SUMMARY

A liquid transfer device with an integrated non-contact liquid fill height sensor. The non-contact liquid fill height sensor integrated into the liquid handling device is used to gauge the elevation of the surface of the liquid or a surface of the container relative to the liquid transfer device. The geometry of typical containers used on the liquid transfer device is known, as well as the distance between surfaces on which these containers rest inside the liquid transfer device. This allows for the computation of the distance between the end of the pipet tip and the liquid surface, and to control the device to ensure that the pipet tip only submerges to the desired depth. It also allows for the measurement of liquid fill heights and the computation of liquid volumes in the container before and after a liquid transfer.

In the case of non-contact dispensing into vials or vessels, a non-contact fill height sensor can be used to stop dispensing when the desired fill height is reached. Once the distance between the sensor and the surface of the liquid has been determined, the control unit of the liquid transfer device can compute the instructions needed to move the pipet tip in any desired position relative to the sample surface.

Being able to move the pipet tip to a defined position relative to the surface of the container is particularly useful to avoid the problem of inadvertently sealing the opening of the pipet tip by pressing it against the bottom of the container. In this scenario, aspiration is hampered, and reproducible liquid transfers are no longer possible. Similarly, if a dispense step is desired, it is often advantageous to move the opening of the pipet tip close to the bottom of the container, as discussed above, and it is important to ensure that the opening of the pipet tip is not pressed against the bottom of the container, thus sealing the opening and precluding liquid from leaving the pipet tip in a reproducible manner.

An integrated non-contact fill height sensor can also be used to independently measure liquid fill height or volume in a container. This information can be used to rapidly determine how much liquid should be added to the container, for example to re-constitute the liquid in the container to a desired fill height level, or to ensure that the fill height of the container after the dispense does not exceed a desired maximum level.

If the liquid fill height or volume in the container is measured before and after a volume of liquid has been dispensed into it, the volume of liquid that has been added to the container can be calculated and reported to the user.

Similarly, an integrated non-contact fill height sensor can be used to measure the liquid fill height or volume in the container before a desired volume of liquid is aspirated from it. If the measurement finds that the remaining volume in the container is less than the desired aspirate volume, a user or a control algorithm can be alerted to take corrective action. After a volume of liquid has been aspirated from a container, the remaining volume of liquid in the container can be measured with the integrated fill height sensor. Knowing the remaining volume in the container is useful for inventory tracking, or to alert a user or a control algorithm if the remaining volume is below a previously set threshold.

In one aspect, a system for transferring a volume of liquid into or out of a container that is configured to hold the liquid, wherein the liquid in the container has a free surface, includes a liquid transfer mechanism, a non-contact distance sensor, and a control unit. The control unit is configured to position the non-contact distance sensor such that the distance sensor can be used to determine the distance between the distance sensor and the container and the distance between the distance sensor and the free surface of the liquid in the container, record the position of the distance sensor when the distance is determined, and position the liquid transfer mechanism in a desired position relative to the free surface of the liquid in the container or in a desired position relative to the container, wherein the desired position is calculated based on the determined distance between the distance sensor and the container or the free surface of the liquid in the container and the recorded position of the distance sensor when this distance was determined and a desired relative position of the liquid transfer mechanism and the container or the free surface of the liquid in the container.

Embodiments may include one of the above and/or below features, or any combination thereof. The non-contact distance sensor may be a low-coherence interferometric fill height sensor, an ultrasonic distance sensor, a sensor based on optical triangulation, or an optical confocal sensor. The non-contact distance sensor may be attached to the liquid transfer mechanism.

In another aspect, a system for transferring a volume of liquid into or out of a container that is configured to hold the liquid, wherein the liquid in the container has a free surface, includes a liquid transfer mechanism, a non-contact distance sensor, and a control unit. The control unit is configured to position the non-contact distance sensor such that the distance sensor can be used to determine the distance between the distance sensor and the container and the distance between the distance sensor and the free surface of the liquid in the container, record the position of the distance sensor when the distances are determined, calculate the fill heights of the liquid in the container before and after the liquid transfer based on differences of the determined distance of the container from the sensor, and the determined distance to the free surface of the liquid in the container or the container before and after the liquid transfer, and transfer a desired volume of liquid to or from the container using the calculated fill heights and the liquid transfer mechanism.

Embodiments may include one of the above and/or below features, or any combination thereof. The control unit may be further configured to calculate the volume of the liquid in the container before and after a liquid transfer based on known dimensions of the container and the fill heights of the liquid in the container before and after a liquid transfer. The non-contact distance sensor may be a low-coherence interferometric fill height sensor, an ultrasonic distance sensor, a sensor based on optical triangulation, or an optical confocal sensor. The non-contact distance sensor may be attached to the liquid transfer mechanism.

In another aspect, a method for transferring a volume of liquid into or out of a container that is configured to hold the liquid, wherein the liquid in the container has a free surface, the method using a liquid transfer mechanism, a non-contact distance sensor, and a control unit, includes using the control unit to position the non-contact distance sensor such that the distance sensor can be used to determine the distance between the distance sensor and the container and the distance between the distance sensor and the free surface of the liquid in the container, record the position of the distance sensor when the distance is determined, and position the liquid transfer mechanism in a desired position relative to the free surface of the liquid in the container or in a desired position relative to the container, wherein the desired position is calculated based on the determined distance between the distance sensor and the container or the free surface of the liquid in the container and the recorded position of the distance sensor when this distance was determined and a desired relative position of the liquid transfer mechanism and the container or the free surface of the liquid in the container.

Embodiments may include one of the above and/or below features, or any combination thereof. The non-contact distance sensor may be a low-coherence interferometric fill height sensor, an ultrasonic distance sensor, a sensor based on optical triangulation, or an optical confocal sensor. The non-contact distance sensor may be attached to the liquid transfer mechanism.

In another aspect, a method for transferring a volume of liquid into or out of a container that is configured to hold the liquid, wherein the liquid in the container has a free surface, the method using a liquid transfer mechanism, a non-contact distance sensor, and a control unit, includes using the control unit to position the non-contact distance sensor such that the distance sensor can be used to determine the distance between the distance sensor and the container and the distance between the distance sensor and the free surface of the liquid in the container, record the position of the distance sensor when the distances are determined, calculate the fill heights of the liquid in the container before and after the liquid transfer based on differences of the determined distance of the container from the sensor, and the determined distance to the free surface of the liquid in the container or the container before and after the liquid transfer, and transfer a desired volume of liquid to or from the container using the calculated fill heights and the liquid transfer mechanism.

### BRIEF DESCRIPTION OF THE DRAWINGS

FIG. 1 is a diagram of a liquid transfer system that uses an integrated non-contact fill height sensor.

FIG. 2 is a schematic illustration of the measurement of the distance to the liquid surface using a liquid transfer device with an integrated non-contact liquid fill height sensor.

FIG. 3 illustrates the measurement of the distance to the bottom of an empty container using a liquid transfer device with an integrated non-contact liquid fill height sensor.

FIG. 4 illustrates the submergence of the pipet tip to a desired depth into liquid in a container, using a liquid transfer device with an integrated non-contact liquid fill height sensor.

FIG. 5 illustrates positioning the pipet tip at a desired distance from the bottom of a container, using a liquid transfer device with an integrated non-contact liquid fill height sensor.

FIGS. 6A-6C illustrate a disposable tip pickup step from a tip rack, using a liquid transfer device with an integrated non-contact liquid fill height sensor.

FIG. 7 is a schematic illustration of the measurement of the distance to the liquid surface using a liquid transfer device with an integrated non-contact liquid fill height sensor where the active element and the detector element of the non-contact distance sensor are physically separate and the axis of measurement of the non-contact liquid fill height sensor and the axis of the pipet tip coincide.

FIG. 8 is a schematic depiction of a liquid transfer device with an integrated non-contact liquid fill height sensor mounted on a separate arm from the pipetting arm.

FIG. 9A is a schematic depiction of different positions on the surface of a volume of liquid held in a container

FIG. 9B is a schematic depiction of different positions on the bottom of a container

FIG. 9.C is a schematic depiction of a multicontainer assembly.

### REFERENCE NUMERALS USED IN THE DRAWINGS

8 liquid transfer system

10 pipetting arm of the liquid transfer device

10A rod that is translated in the direction of z in coordinate system 14, and to which pipet tip 12 and non-contact distance sensor 22 is affixed

10B z-motor unit that translates rod 10A in the direction of z in coordinate system 14, following actuation by control unit 50 through data connection 70

11 separate arm of the liquid transfer device onto which the non-contact distance sensor is mounted

12 pipet tip

14 coordinate system

16 liquid surface

16A-F arrows indicating different points on a liquid surface 16

18 container

18A-C individual containers in a multiplex container container bottom

20A-C arrows indicating different points on a container bottom 20

22 non-contact distance sensor

22A active element of non-contact distance sensor

22B detector element of non-contact distance sensor

24 solid angle of the signal sent from the active element in sensor 22 to surface 16 or 20 and of the reflected signal captured by the detector element in sensor 22

24A solid angle of the signal sent from active element 22A to surface 16 or 20 and of the reflected signal captured by the detector element in sensor 22

24B solid angle of the signal reflected by surface 16 or 20 and captured by detector element 22B

26 lateral distance in the xy plane of coordinate system 14 between axis 34 of the tip and the axis defined by solid angle 24

28 vertical distance in z in coordinate system 14 between the tip of pipet tip 12 and surface 16 of the liquid in container 18

30 vertical distance in z in coordinate system 14 between non-contact sensor 22 and the surface 16 of the liquid in container 18

32 vertical distance in z in coordinate system 14 between the tip of pipet tip 12 and non-contact distance sensor 22

34 axis of pipet tip 12

36 depth of submergence of the tip of pipet tip 12 beneath surface 16 of the liquid in container 18

38 elevation of the tip of pipet tip 12 above interior bottom surface 20 of empty container 18

40 pipet tip rack

50 control unit

52 x-translation stage that translates z-motor unit 10B and the elements attached to it in the direction of x in coordinate system 14, following actuation by control unit 50 through data connection 68

54 y-translation stage that translates x-motor unit 52 and the elements attached to it in the direction of y in coordinate system 14, following actuation by control unit 50 through data connection 64

56 deck of the liquid transfer device, on which containers rest during liquid transfers

58 vertical support members that hold y-translation stage 54 in a fixed position relative to deck 56

60 container placement aides that guide the placement of container 20 in positions with defined x, y, and z coordinates in coordinate system 14 on deck 56

62 syringe pump that is actuated by control unit 50 through data connection 72 and connected to the opening of pipet tip 12 via tubing 74 and configured to withdraw or dispense liquid through the opening of pipet tip 12

64 data connection between control unit 50 and y-translation stage 54

66 data connection between control unit 50 and non-contact distance sensor 22

68 data connection between control unit 50 and x-translation stage 52

70 data connection between control unit 50 and z-motor unit 10B

72 data connection between control unit 50 and syringe pump 62

74 tubing that connects syringe pump 62 and pipet tip 12

### DETAILED DESCRIPTION

### Description of First Embodiment

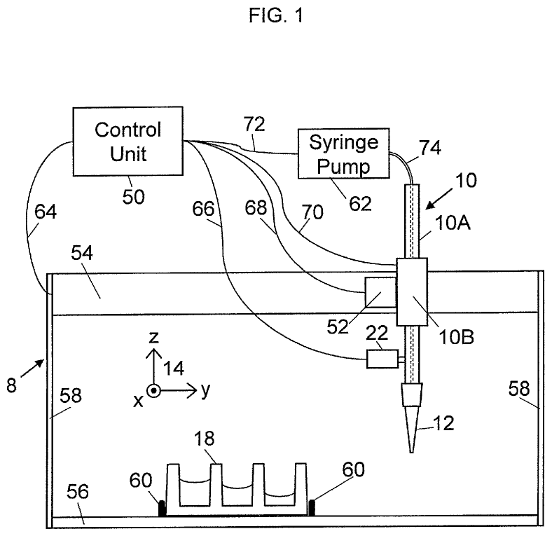

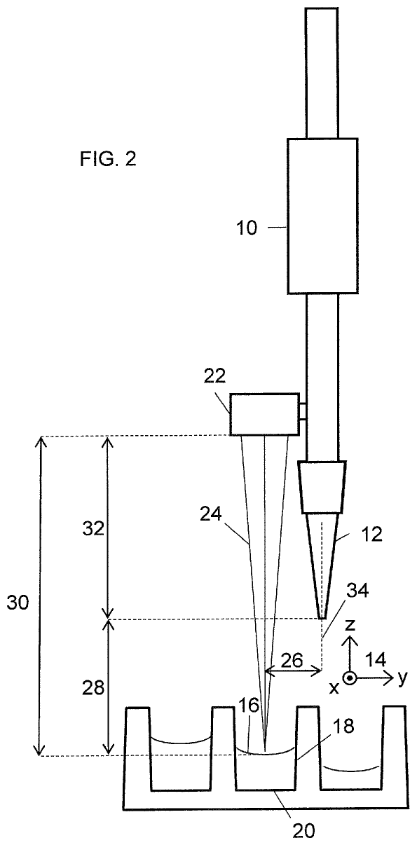

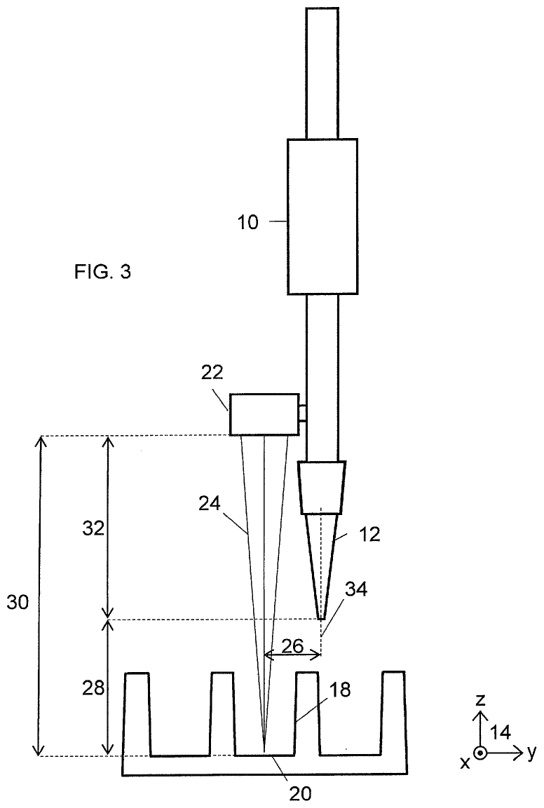

Liquid transfer system 8 is depicted in FIG. 1. A more detailed view of the pipetting arm of liquid transfer system 8 is depicted in FIG. 2. As is known in commercially available devices in the prior art, pipetting arm 10 moves pipet tip 12 relative to container 18, which is held on deck 56 in a position defined by container placement aides 60. Once pipet tip 12 is in the appropriate position relative to liquid surface 16 formed by liquid in container 18 or in the appropriate position relative to a surface (e.g., bottom surface 20) of container 18, liquid aspiration or liquid dispensing begins. In this embodiment a non-contact distance sensor 22 is attached to the liquid transfer device in such a manner that pipetting tip 12 of the liquid transfer device is in a fixed, known position relative to non-contact distance sensor 22, which is used as a non-contact liquid fill height sensor. In operation, non-contact distance sensor 22 is moved above a container 18 that may be filled with liquid, such as a microplate well. An active element in sensor 22 emits a signal that emanates from non-contact distance sensor 22 and is partially reflected at a surface of container 18 or at liquid surface 16. A portion of the reflected signal is captured by a detection element in sensor 22.

In one embodiment, sensor 22 is a low-coherence interferometric fill height sensor as described in PCT Int. Appl. PCT/US2015/043910 by Luedemann, the entirety of which is incorporated herein by reference. In this embodiment, the active element in the sensor is a light source which emits light that is directed towards surface 16 of the liquid or surface 20 of container 18. A portion of this light is reflected towards sensor 22, where it is collected and detected by a detector element and distance 30 from sensor 22 to reflecting surface 20 of container 18 or reflecting liquid surface 16 is determined. In one embodiment, the variation of the difference between sample and reference path lengths in the low-coherence interferometer is accomplished by keeping the reference path length constant and using the movement of pipetting arm 10 to which non-contact distance sensor 22 is affixed to vary the sample path length.

In another embodiment, the non-contact distance sensor is an ultrasonic sensor such as those manufactured by Baumer AG (Frauenfeld, Switzerland) or Sensopart Industriesensorik GmbH (Gottenheim, Germany). In this embodiment, the active element of sensor 22 directs an ultrasound wave towards surface 16 of the liquid or surface 20 of container 18. A portion of the ultrasound wave is reflected toward sensor 22, where it is detected by a detection element and distance 30 between sensor 22 and liquid surface 16 or container surface 20 is determined.

In another embodiment, non-contact distance sensor 22 is an optical sensor based on triangulation. In this embodiment, the active element of sensor 22 directs a beam of light towards surface 16 of the liquid or surface 20 of container 18. Distance 30 between reflecting surface 16 or 20 and sensor 22 determines the location where the reflected beam of light impinges on the detection element of sensor 22, and this location is used to determine distance 30 between the sensor and the liquid or container surface.

In another embodiment, non-contact distance sensor 22 is a confocal optical sensor. In this embodiment, the active element of sensor 22 directs a conical beam of light towards the surface 16 of the liquid or surface 20 of container 18 and the detection element of sensor 22 is configured such that it detects maximum intensity when it is at a confocal distance from the reflecting surface.

### Operation of First Embodiment

To begin a liquid aspiration or dispense step or to perform a measurement of the fill height of the liquid in container 18, control unit 50 causes non-contact distance sensor 22 to move into a position such that it can perform a distance measurement of distance 30 between non-contact distance sensor 22 and surface 16 of the liquid or a surface of container 18 such as surface 20.

This position, in which non-contact sensor 22 can perform a distance measurement to a desired point on the surface 16 of the liquid or a surface 20 of container 18 is determined by the known positions of container placement aides 60 on deck 56, which, in turn, define the position of container 18 on the deck, by the known geometry of container 18, and by the working distance range of non-contact distance sensor 22. Control unit 50 comprises a processor and associated memory. Control unit 50 is configured in such a manner that it stores in its internal memory the positions of container placement aides 60 on deck 56, the known geometry of container 18, and the working distance range of non-contact distance sensor 22.

Control unit 50 translates z-rod 10A (FIG. 1) and non-contact distance sensor 22 and pipet tip 12, which are affixed to z-rod 10A, in the direction of z in coordinate system 14 by sending instructions through data connection 70 to z-motor unit 10B to place z-rod 10A in a desired z-position. Z-motor unit 10B is affixed to x-translation stage 52. Control unit 50 translates x-translation stage 52 in the direction of x in coordinate system 14 by sending instructions through data connection 68 to place z-motor unit 10B, z-rod 10A, and non-contact distance sensor 22 and pipet tip 12, which are affixed to z-rod 10A, in a desired x-position in coordinate system 14. X-translation stage 52 is affixed to y-translation stage 54. Control unit 50 translates y-translation stage 54 in the direction of y in coordinate system 14 by sending instructions through data connection 64 to place x-translation stage 52, z-motor unit 10B, z-rod 10A, and non-contact distance sensor 22 and pipet tip 12, which are affixed to z-rod 10A, in a desired y-position in coordinate system 14.

Control unit 50 is further configured to hold calibration data in its internal memory that relate the current position of x-translation stage 52 to the x-coordinates of non-contact distance sensor 22 and pipet tip 12 in coordinate system 14, the current position of y-translation stage 54 to the y-coordinates of non-contact distance sensor 22 and pipet tip 12 in coordinate system 14, and the current position of z-rod 10A in z-motor unit 10B to the z-coordinates of non-contact distance sensor 22 and pipet tip 12 in coordinate system 14.

In this manner, control unit 50 positions non-contact distance sensor 22 and pipet tip 12 into any desired position within its spatial operating range.

Control unit 50 is further configured to issue instructions to perform a distance measurement to non-contact distance sensor 22 through data connection 66, and to receive the results of the distance measurement through data connection 66.

Control unit 50 uses the positions of container placement aides 60 on deck 56, the known geometry of container 18, and the working distance range of non-contact distance sensor 22, all of which it holds in its internal memory, to calculate the xyz coordinates of a position in which non-contact distance sensor 22 can perform a measurement of the distance between sensor 22 and a desired point on the surface 16 of the liquid and/or a surface 20 of container 18. Control unit 50 calculates the xyz coordinates of such a position of sensor 22 in the following manner.

Control unit 50 adds the difference in the x-coordinates of a reference edge of container 18 and the x-coordinate of the desired position on container 18 to the known x-position of container placement aides 60 to arrive at the x-coordinate in which sensor 22 is to be placed for the measurement. Control unit 50 then adds the difference in the y-coordinates of a reference edge of container 18 and the y-coordinate of the desired position on container 18 to the known y-position of container placement aides 60 to arrive at the y-coordinate in which sensor 22 is to be placed for the measurement. These xy coordinates allow control unit 50 to place sensor 22 vertically above the desired point on the surface 16 of the liquid, and the only remaining coordinate is the z-coordinate of the position, which is selected such that distance 30 between sensor 22 and surface 16 of the liquid is within the working distance range of the sensor.

To arrive at the z-coordinate of the position, control unit 50 adds: the z-coordinate of container placement aides 60, which define the position of the exterior of the bottom of container 18 and which control unit 50 holds in its internal memory; the difference in z-coordinates between the exterior of the bottom of container 18 and the interior wall of container 18, which control unit 50 holds in its internal memory as a part of the known geometry of container 18; the difference between the z-coordinates of the interior wall of container 18 and the surface 16 of the liquid, which is the anticipated liquid fill height; and a distance within the working distance range of sensor 22.

In one embodiment, control unit 50 positions non-contact distance sensor 22 above the center of the container in the xy plane and calculates the necessary xyz coordinates as described above.

In the case where a measurement to surface 16 of the liquid is desired, control unit 50 then issues instructions to sensor 22 to measure distance 30 to surface 16 of the liquid, and receives the measured distance through data connection 66. Control unit 50 then adds the measured distance 30 between sensor 22 and surface 16 of the liquid to the previously recorded xyz position of the sensor to derive the xyz coordinates of the measured point on the surface 16 of the liquid.

In the case where a measurement to surface 20 of container 18 is desired, control unit 50 adds the following to arrive at the z-coordinate of the position of sensor 22 for the measurement: the z-coordinate of container placement aides 60, which define the position of the exterior of the bottom of container 18 and which control unit 50 holds in its internal memory; the difference in z-coordinates between the exterior of the bottom of container 18 and the upper surface of the wall of container 18, which control unit 50 holds in its internal memory as a part of the known geometry of container 18; and a distance within the working distance range of sensor 22.

In the case where a measurement to surface 20 of container 18 is desired, control unit 50 then issues instructions to sensor 22 to measure distance 30 to surface 20 of container 18, and receives the measured distance through data connection 66. Control unit 50 then adds the measured distance 30 between sensor 22 and surface 20 of container 18 to the previously recorded xyz position of the sensor to derive the xyz coordinates of the measured point on the surface 20 of container 18.

Control unit 50 then places pipet tip 12 in a desired position relative to the xyz positions of the measured point on the surface 16 of the liquid or surface 20 of container 18 to begin the aspirate or dispense step.

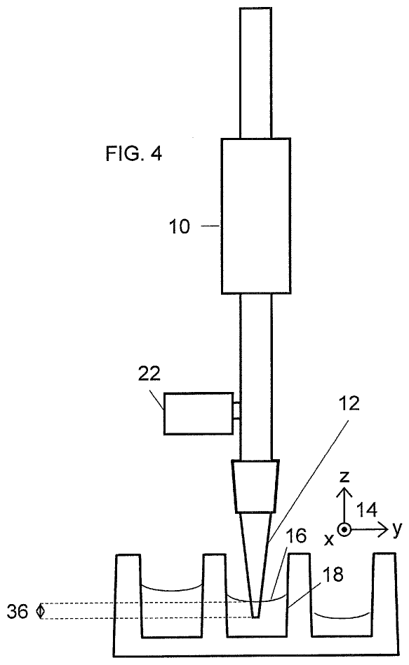

In the case of an aspirate step, control unit 50 derives the desired position of pipet tip 12 by subtracting depth of submergence 36 of the tip of pipet tip 12 beneath surface 16 of the liquid in container 18 from the determined z-coordinate of the position of the surface 16 of the liquid, as shown in FIG. 4.

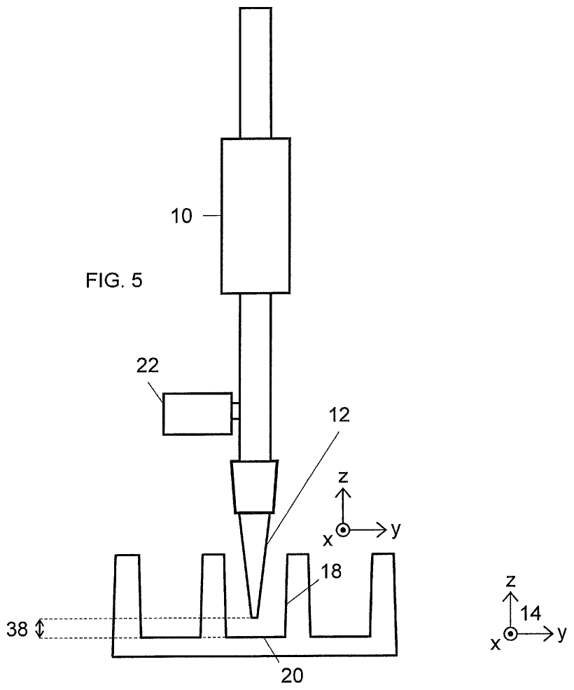

In the case of a dispense step, control unit 50 derives the desired position of pipet tip 12 by adding the desired elevation 38 of the tip of pipet tip 12 above bottom surface 20 of empty container 18 to the determined z-coordinate of the position on the surface 16 of the liquid, or to the determined z-coordinate of the position on the interior surface of container 18 as shown in FIG. 5, for the case of a dispense step into an empty container.

In one embodiment, when liquids are to be dispensed that drip easily from the pipet tip as pipetting arm 10 of the liquid transfer device moves, measurement and dispensing steps can be separated. In this embodiment, the attached non-contact distance sensor is moved to its measurement position above the container as described above, a distance measurement is carried out, and only then is pipet tip 12 moved to the source container, where liquid is aspirated and then moved to the destination container, where the distance measurement taken before the aspirate step is used by the control unit of the liquid transfer device to perform the dispense step in an ideal position.

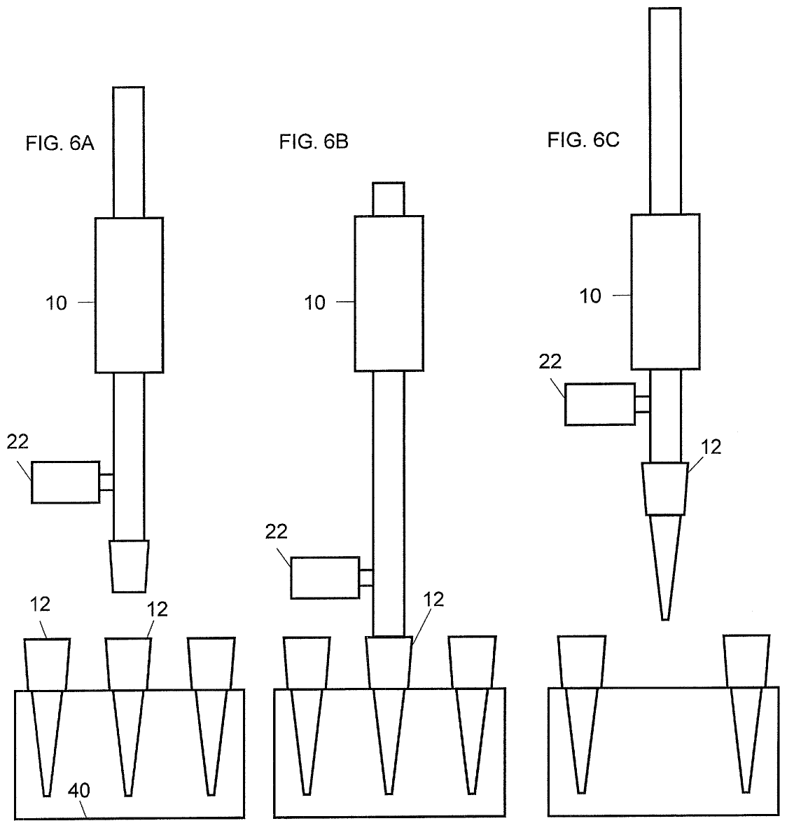

In one embodiment suitable for cases where pipetting arm 10 of the liquid transfer device is fitted with disposable tips, a conical feature at the end of pipetting arm 10 is pressed into disposable pipet tip 12 which in turn is held in pipet tip rack 40. Non-contact sensor 22 is mounted on pipetting arm 10 in such a way that it does not interfere with pick-up of disposable pipet tips 12 from pipet tip rack 40, as illustrated in FIG. 6.

In another embodiment, the non-contact distance sensor 22 is used to perform one or several distance measurements of distance 30 between non-contact distance sensor 22 and surface 16 of the liquid or a surface of container 18 such as surface 20 and the control unit of the liquid transfer device uses these measurements to calculate the volume of liquid in container 18.

In yet another embodiment, the control unit of the liquid handling device compares the measured volume in the container with instructions it has received for transferring liquid into or out of container 18. For example, if the liquid transfer device has received an instruction to aspirate a volume of liquid from container 18 that exceeds the volume present in container 18, the control unit of the liquid transfer device could issue an alert to the user or modify the liquid transfer instructions. Similarly, if the liquid transfer device has received an instruction to dispense a volume of liquid into container 18 that would lead to the fill height of the liquid in container 18 to exceed a desirable maximum level, the control unit of the liquid transfer device could issue an alert to the user or modify the liquid transfer instructions.

In another embodiment, the control unit of the liquid handling device compares the difference in the measured volumes in the container before and after a dispense step to measure the volume that was actually dispensed into the container.

In one embodiment, the control unit reports this measured delivery volume to the user.

In one embodiment, the control unit then compares this measured volume with the target volume it instructed the liquid handling device to transfer into the container and notes any deviations between actual and target volume. The control unit then recalibrates the liquid transfer device to reduce deviations between target and actual volume.

### Description of Second Embodiment

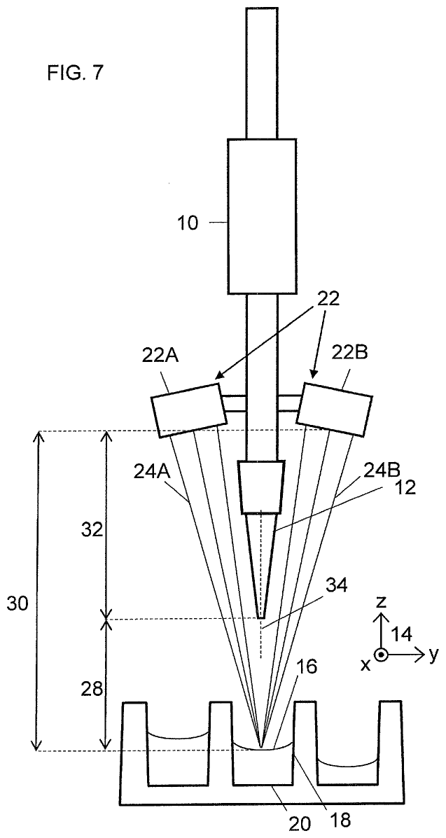

In this embodiment, depicted in FIG. 7, non-contact distance sensor 22 is attached to pipetting arm 10 of a liquid transfer device in such a manner that active element 22A of sensor 22 and detector element 22B of sensor 22 are physically separated. This arrangement makes it possible that the measurement axis of sensor 22 comprised of active element 22A and detector element 22B can coincide with vertical axis 34 of pipet tip 12. The measurement axis is the axis on which distance measurements to either a surface of container 18 such as surface 20 or to surface 16 of the liquid are carried out. Because this embodiment leads to superimposed axes, it obviates the need for a lateral movement of pipet tip 12 in the xy plane of coordinate system 14 after the non-contact distance measurement has been carried out and before the liquid transfer step can be performed. In this embodiment, pipet tip 12 of pipetting arm 10 of the liquid transfer device is in a fixed, known position relative to non-contact distance sensor 22 comprised of active element 22A and detector element 22B. In operation, the non-contact distance sensor is moved above a container 18 that may be filled with liquid, such as a microplate well. Active element 22A in the sensor emits a signal into solid angle 24A that is partially reflected at surface 20 of container 18 or surface 16 of the liquid. The portion of the signal reflected into solid angle 24B is captured by detection element 22B of the sensor.

As in the embodiment where active element and detector element of the non-contact sensor are not separate, in one embodiment, the sensor is a low-coherence interferometric fill height sensor as described in PCT Int. Appl. PCT/US2015/043910 by Luedemann. In this embodiment, active element 22A in the sensor is a light source which emits light that is directed towards surface 16 of the liquid or surface 20 of container 18. A portion of this light is reflected into solid angle 24B towards detector element 22B of the sensor, where it is collected and detected and distance 30 from the sensor to reflecting surface 20 of container 18 or liquid surface 16 is determined.

In one embodiment, the variation of the difference between sample and reference path lengths in the low-coherence interferometer is accomplished by keeping the reference path length constant and using the movement of pipetting arm 10 to which non-contact distance sensor 22 is affixed to vary the sample path length.

In another embodiment, the non-contact distance sensor is an ultrasonic sensor such as those manufactured by Baumer AG (Frauenfeld, Switzerland) or Sensopart Industiresensorik GmbH (Gottenheim, Germany). In this embodiment, active element 22A of the sensor directs an ultrasound wave towards surface 16 of the liquid or surface 20 of container 18. A portion of the ultrasound wave is reflected to the sensor, where it is detected by detection element 22B and distance 30 between the sensor and the liquid surface is determined.

In yet another embodiment, the non-contact distance sensor is an optical sensor based on triangulation. In this embodiment, the active element 22A of the sensor directs a beam of light towards surface 16 of the liquid or surface 20 of container 18. The distance 30 between the reflecting surface and the sensor determines the location where the reflected beam of light impinges on the detection element 22B, and this location is used to determine the distance between the sensor and the liquid surface.

### Operation of Second Embodiment

To begin a liquid aspiration or dispense step or to perform a measurement of the fill height of the liquid in container 18, control unit 50 causes the non-contact distance sensor comprised of active element 22A and detector element 22B to move into a position such that it can perform a distance measurement of distance 30 between non-contact distance sensor 22 and surface 16 of the liquid or a surface of container 18 such as surface 20, in a manner analogous to the description of the operation of the first embodiment above.

In this embodiment, the elements of the non-contact distance sensor are mounted in such a manner that the axis of measurement of the non-contact distance sensor and axis 34 of pipet tip 12 coincide. In one embodiment, the non-contact distance measurement would be taken such that the non-contact distance sensor is positioned above the center of the container in the xy plane denoted by coordinate system 14. To perform the measurement, the non-contact distance sensor comprised of active element 22A and detector element 22B is placed at a z-height so that distance 30 between the sensor and surface 16 of the liquid or surface 20 of container 18 along the z-axis denoted by coordinate system 14 are within the sensor's working distance range. Once distance 30 from the non-contact distance sensor comprised of active element 22A and detector element 22B to the bottom 20 of empty container 20 or the distance from the sensor to surface 16 of the liquid has been measured, the control unit of the liquid transfer device issues commands to incrementally move pipet tip 12 in the z-direction in the same coordinate system to place the pipet tip in the desired position relative to container 18 to begin the aspirate or dispense step. In this embodiment, the axes of measurement and of the pipet tip coincide, so no additional movement in the xy-plane defined by the coordinate system 14 is necessary. In one embodiment, the non-contact distance sensor comprised of active element 22A and detector element 22B is used to perform one or several distance measurements of distance 30 between non-contact distance sensor 22 and surface 16 of the liquid or a surface of container 18 such as surface 20 and the control unit of the liquid transfer device uses these measurements to calculate the volume of liquid in container 18.

In one embodiment, the control unit of the liquid handling device calculates the volume of liquid in container 18 from these measurements while the pipetting arm 10 travels the vertical distance 30 in the direction of z in coordinate system 14, between the z-position where the non-contact distance sensor comprised of active element 22A and detector element 22B performs a fill height measurement and the z-position where the tip of pipet tip 12 is in its desired position relative to container 18.

### Description of Third Embodiment

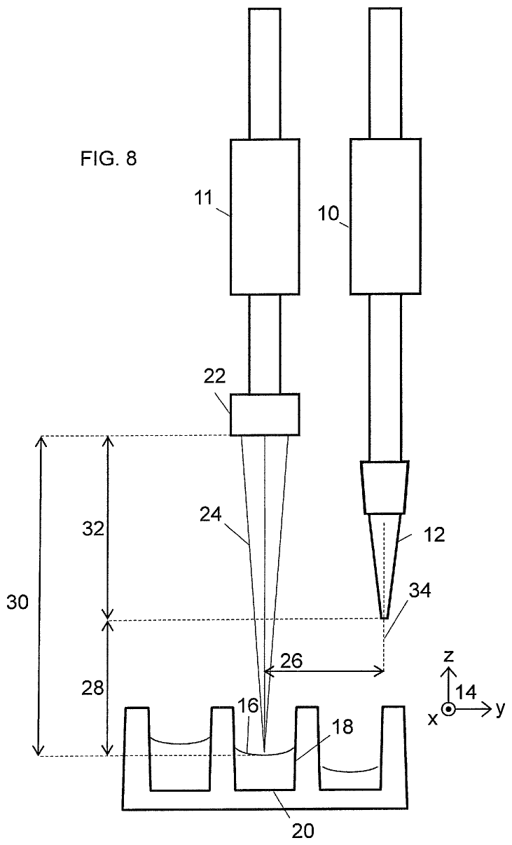

In this embodiment, depicted in FIG. 8, non-contact distance sensor 22 is attached to an arm 11 of a liquid transfer device that is different from its pipetting arm 10. In this embodiment, the control unit of the liquid transfer device tracks the positions of the arm 11 carrying the non-contact distance sensor 22 and of the pipetting arm 10 to which pipet tip 12 is attached. Tracking both positions, the control unit calculates the lateral distance 26 in the xy plane of coordinate system 14 between axis 34 of pipet tip 12 and the axis defined by solid angle 24. The control unit also calculates the vertical distance 32 in z of coordinate system 14 between the tip of pipet tip 12 and non-contact distance sensor 32.

In one embodiment, sensor 22 is a low-coherence interferometric fill height sensor as described in PCT Int. Appl. PCT/US2015/043910 by Luedemann. In this embodiment, the active element in the sensor is a light source which emits light that is directed towards surface 16 of the liquid or surface 20 of container 18. A portion of this light is reflected towards sensor 22, where it is collected and detected by a detector element and distance 30 from sensor 22 to reflecting surface 20 of container 18 or reflecting liquid surface 16 is determined. In one embodiment, the variation of the difference between sample and reference path lengths in the low-coherence interferometer is accomplished by keeping the reference path length constant and using the movement of arm 11, to which non-contact distance sensor 22 is affixed, to vary the sample path length.

In another embodiment, the non-contact distance sensor is an ultrasonic sensor such as those manufactured by Baumer AG (Frauenfeld, Switzerland) or Sensopart Industriesensorik GmbH (Gottenheim, Germany). In this embodiment, the active element of sensor 22 directs an ultrasound wave towards surface 16 of the liquid or surface 20 of container 18. A portion of the ultrasound wave is reflected toward sensor 22, where it is detected by a detection element and distance 30 between sensor 22 and liquid surface 16 is determined.

In yet another embodiment, non-contact distance sensor 22 is an optical sensor based on triangulation. In this embodiment, the active element of sensor 22 directs a beam of light towards surface 16 of the liquid or surface 20 of container 18. Distance 30 between reflecting surface 16 and sensor 22 determines the location where the reflected beam of light impinges on the detection element of sensor 22, and this location is used to determine distance 30 between the sensor and the liquid surface.

In yet another embodiment, the non-contact sensor 22 is temporarily affixed to arm 11 of the liquid transfer device and at times when the non-contact sensor 22 is not affixed to arm 11 or arm 11 and the affixed sensor 22 are not performing measurements, arm 11 is used for other purposes, such as, for example, to move containers or microplates between different positions in the liquid transfer device.

### Operation of Third Embodiment

In this embodiment, the control unit of the liquid handling device positions arm 11, to which non-contact distance sensor 22 is affixed, such that non-contact sensor 22 can perform a distance measurement of distance 30 between non-contact distance sensor 22 and surface 16 of the liquid or a surface of container 18 such as surface 20, in a manner analogous to the descriptions of the previous embodiments. In one embodiment, this measurement would be taken such that the non-contact distance sensor is positioned above the center of the container in the xy plane denoted by the coordinate system 14, as depicted in FIG. 8. To perform the measurement, non-contact distance sensor 22 is placed at a z-height so that distance 30 between the sensor and a surface of container 18 such as surface 20 or distance 30 between sensor 22 and surface 16 of the liquid in the z-axis denoted by coordinate system 14 remain within the working distance range of non-contact distance sensor 22. The instrument then measures the distance 30 from sensor 22 to the bottom 20 of empty container 18 or distance 30 from sensor 22 to surface 16 of the liquid.

In one embodiment, the control unit of the liquid transfer device uses this distance to calculate the fill height or the volume of the liquid held in container 18.

In another embodiment, if a liquid transfer is desired, the control unit of the liquid transfer device moves arm 11 of the liquid transfer device from its position and moves pipetting arm 10 into such a position that the tip of pipet tip 12 is the correct position relative to container 18 or liquid surface 16 for the desired liquid transfer step.

In yet another embodiment, the control unit of the liquid transfer device moves the non-contact distance sensor 22 in the xy plane in coordinate system 14 in such a manner that several measurements of the distance between the sensor and the surface of the container 18 or the surface 16 of the liquid can be carried out.

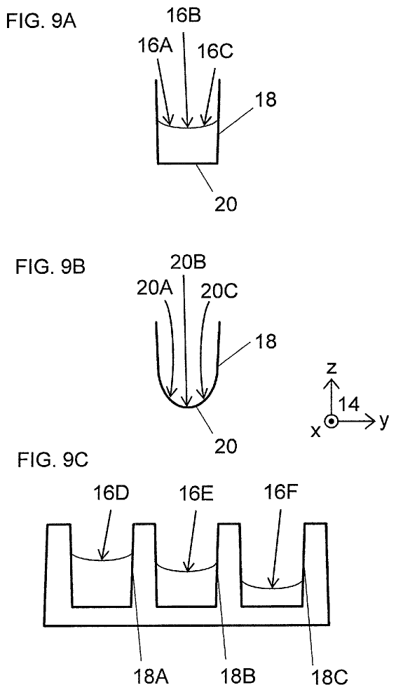

In one embodiment, these several measurements are carried out at different points, indicated by arrows 16A-16C in FIG. 9A on the surface 16 of the liquid in container 18 and the resulting measurements are used to calculate the shape of the liquid meniscus of the surface 16 of the liquid in container 18.

In one embodiment, these several measurements are carried out at different points, indicated by arrows 20A-20C in FIG. 9B on the surface 20 of the container holding the liquid and the resulting measurements are used to calculate the shape of the container 18 holding the liquid. The container depicted in FIG. 9B as an illustrative example is a round-bottom container as it is commonly found in the industry.

In another embodiment, these several measurements are carried out on the surfaces 16D-F of different aliquots of liquid, which are each held in different containers 18A-C as depicted in FIG. 9C. A common example in the industry are microplates, which contain several containers, each designed to hold a small volume of liquid.

In yet another embodiment, these several measurements are carried out while arm 11 that moves sensor 22 across different points on the surface 16 of a liquid, across different points on the surface of a container 18, or across different containers in a multi-container assembly such as a microplate.

A number of implementations have been described. Nevertheless, it will be understood that additional modifications may be made without departing from the scope of the inventive concepts described herein, and, accordingly, other embodiments are within the scope of the following claims.

What is claimed is:

1. A system for transferring liquid into or out of a container that is configured to hold the liquid, and measuring the height of a free surface of the liquid in the container, wherein the container is placed in a known position relative to the system, the system comprising:
a liquid transfer mechanism configured to transfer liquid into or out of the container;
a non-contact distance sensor configured to measure the position of the free surface of the liquid relative to the system; and
a control unit configured to calculate the height of the free surface of the liquid in the container based on a difference between the measured position of the free surface and the known position of the container.

2. The system of claim 1, wherein the control unit is further configured to calculate the volume of the liquid in the container before a liquid transfer based on known dimensions of the container and the height of the free surface of the liquid in the container.

3. The system of claim 1, wherein the non-contact distance sensor is a low-coherence interferometric distance sensor.

4. The system of claim 1, wherein the non-contact distance sensor is an ultrasonic distance sensor.

5. The system of claim 1, wherein the non-contact distance sensor is a sensor based on optical triangulation.

6. The system of claim 1, wherein the non-contact distance sensor is an optical confocal sensor.

7. The system of claim 1, wherein the non-contact distance sensor is attached to the liquid transfer mechanism.

8. The system of claim 1, wherein the control unit is further configured to calculate the volume of the liquid in the container after a liquid transfer based on known dimensions of the container and the height of the free surface of the liquid in the container.

9. A method for transferring liquid into or out of a container that is configured to hold the liquid, and measuring the height of a free surface of the liquid in the container, the method using a liquid transfer mechanism that is configured to transfer liquid into or out of the container, a non-contact distance sensor that is configured to measure the position of the free surface of the liquid relative to the system, and a control unit, the method comprising:
placing the container in a known position; and
using the control unit to calculate the height of the free surface of the liquid in the container based on a difference between the measured position of the free surface and the known position of the container.

10. The method of claim 9, wherein the control unit is further used to calculate the volume of the liquid in the container before a liquid transfer based on known dimensions of the container and the height of the free surface of the liquid in the container.

11. The method of claim 9, wherein the non-contact distance sensor is a low-coherence interferometric distance sensor.

12. The method of claim 9, wherein the non-contact distance sensor is an ultrasonic distance sensor.

13. The method of claim 9, wherein the non-contact distance sensor is a sensor based on optical triangulation.

14. The method of claim 9, wherein the non-contact distance sensor is an optical confocal sensor.

15. The method of claim 9, wherein the non-contact distance sensor is attached to the liquid transfer mechanism.

16. The method of claim 9, wherein the control unit is further used to calculate the volume of the liquid in the container after a liquid transfer based on known dimensions of the container and the height of the free surface of the liquid in the container.
